(19) United States
(12) Patent Application Publication
(10) Pub. No.: US 2015/0367906 A1
(43) Pub. Date: Dec. 24, 2015

(54) POSITIONING DEVICE FOR A JOINT OF A THREE-WHEEL STROLLER

(71) Applicant: ZheJiang JinBang Sports Equipment Co., Ltd., Lishui (CN)

(72) Inventor: Yongqiang Xu, Hangzhou (CN)

(21) Appl. No.: 14/553,569

(22) Filed: Nov. 25, 2014

(30) Foreign Application Priority Data
Jun. 21, 2014 (CN) 201420335118.5

(51) Int. Cl. B62K 13/00; B62K 5/06

(52) U.S. Cl. CPC B62K 13/00; B62K 5/06

(57) ABSTRACT

A positioning device for a joint of a three-wheel stroller comprising a decorative and protective cover, a front fork joint further comprising a limit groove on each side of the front fork joint, a main pipe joint comprising a long groove located at middle of the main pipe joint, a compression spring is sheathed in the main pipe joint, and a folder adapter, the folder adapter on the outer side of the compression spring comprising folder adapter holes on both sides of the folder adapter, wherein the front fork joint is connected to the main pipe joint through a screw shaft, wherein the front fork joint is connected with the folder adapter through a linkage, and wherein the decorative and protective cover is on the outer side of the front fork joint and the folder adapter.

### CROSS-REFERENCE TO RELATED APPLICATIONS

The present application claims priority based on Chinese Application No. 201420335118.5 filed Jun. 21, 2014, the disclosure of which is hereby incorporated by reference in its entirety.

### TECHNICAL FIELD

The present application relates to a positioning device for a joint of a three-wheel stroller.

### BACKGROUND

The function of existing baby walker is singular. When children started to walk on their own, there is no use for baby walker any more. It creates waste of resources. At the same time, parents often will buy a scooter for their children. There is a need for a stroller which can have the both the function of a baby walker and a scooter. Such device will save significant cost and reduce storage space, and avoid unnecessary waste of resources.

### SUMMARY

The present application is directed to a positioning device for a joint of a three-wheel stroller, which can function as a baby walker and a scooter.

An embodiment of the present application discloses a positioning device for a joint of a three-wheel stroller that can comprise a decorative and protective cover, a front fork joint further comprising a limit groove on each sides of the front fork joint, a main pipe joint can further comprise a long groove located at middle of the main pipe joint, a compression spring is sheathed in the main pipe joint, and a folder adapter, the folder adapter on the outer side of the compression spring can further comprise folder adapter holes on both sides of the folder adapter, wherein the front fork joint is connected to the main pipe joint through a screw shaft, wherein the front fork joint is connected with the folder adapter through a linkage, and wherein the decorative and protective cover is on the outer side of the front fork joint and the folder adapter.

The linkage between the front fork joint and the folder adapter can be a rod may be unloaded quickly.

The front fork joint and the holes of the folder adapter are coaxial.

It is to be understood that both the foregoing general description and the following detailed description are exemplary only and are not necessarily restrictive of the disclosure as claimed. The accompanying drawings, which are incorporated in and constitute a part of the specification, illustrate an embodiment of the disclosure and together with the general description, serve to explain the principle of the disclosure.

### BRIEF DESCRIPTION OF THE DRAWINGS

Further features and advantages of the present device, as well as the structure and operation of various embodiments of the present device, will become apparent and more readily appreciated from the following description or the preferred embodiments, taken in conjunction with the accompanying drawing of which:

FIG. 1 is a schematic section view of the positioning device for a joint of three-wheel stroller;

FIG. 2 is another schematic section view of the positioning device for a joint of three-wheel stroller;

FIG. 3 is a diagram of the positioning device for a joint of three-wheel stroller showing the operation of the device;

FIG. 4 is a diagram of the positioning device for a joint of three-wheel stroller showing the operation of the device;

FIG. 5 is a diagram showing front fork joint and the main pipe joint of the positioning device for a joint of three-wheel stroller;

FIG. 6 is a diagram showing the front fork joint and the main pipe joint of the positioning device for a joint of three-wheel stroller according to the present application;

FIG. 7 is a diagram showing how the device is utilized in the conversion of a three wheel stroller;

FIG. 8 is a diagram showing how the device is utilized in the conversion of a three wheel stroller;

FIG. 9 is a diagram showing how the device is utilized in the conversion of a three wheel stroller; and

FIG. 10 is a diagram showing how the device is utilized in the conversion of a three wheel stroller.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

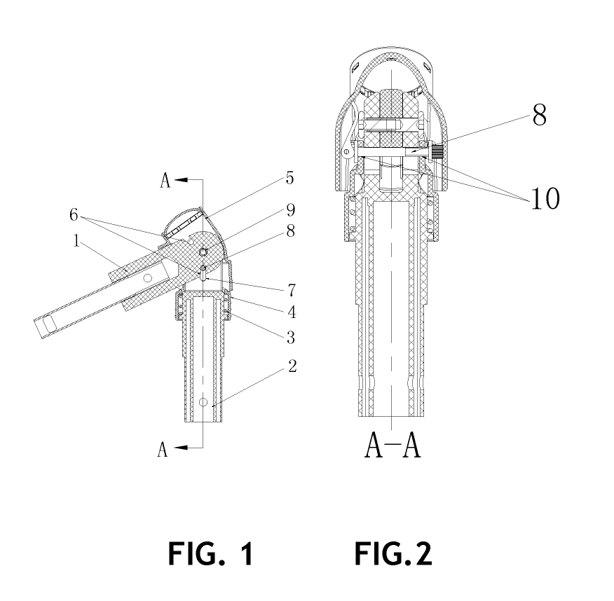

Referring to FIG. 1 to FIG. 10, an embodiment of the present application provides a positioning device for a joint of a three-wheel stroller. The positioning device can comprises a decorative and protective cover 5, a front fork joint 1, a main pipe joint 2 and a folder adapter 4. The front fork joint 1 can comprise a limit groove 6 on each of its two sides. The middle of the main pipe joint 2 further comprise a long groove 7. A compression spring 3 is disposed in on main pipe. A folder adapter 4 is disposed nn the outer side of the compression spring 3. The front fork joint 1 is connected to the main pipe joint 2 through a screw shaft 9. There is a folder adapter hole on each side of the folder adapter 4. The front fork joint 1 is connected to the folder adapter 4 through a linkage. A decorative and protective cover 5 is on the outer side of the front fork joint 1 and the folder adapter 4. The linkage between the front fork joint 1 and the folder adapter 4 is a rod 8 that can be unloaded quickly. The front fork joint 1 and the holes of the folder adapter 4 are coaxial.

Referring to FIG. 1, the front fork joint can be rotated by taking off the decorative and protective cover 5, loosening the rod 8 by pulling down the folder adapter 4, to make the rod 8 come out of the limit groove 6.

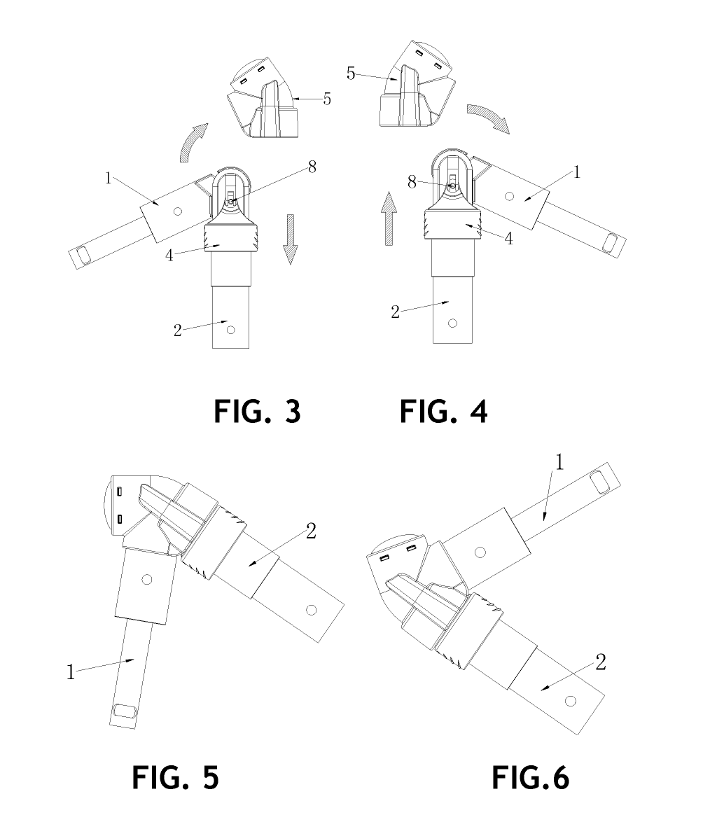

Referring to FIG. 3-4, during the rotation, the folder adapter 4 is pulled toward the direction in which the compression spring 3 is placed in the compressed state. The rod 8 is loosened into one end of the long groove 7 which does not align with the limit groove 6. As the front fork shaft rotates to the other side of the front fork joint 1, the limit groove 6 on the other side of the front fork joint 1 will coincide with the long groove 7. The folder adapter 4 is moved in the opposite direction by releasing the compression spring 3 from compressed state. The folder adapter 4 pushes the rod 8 to be snapped into the limit groove 6. After the rod 8 is locked, the decorative and protective cover 5 is put back in a reversed position. Through this process, the front fork joint 1 and the main pipe joint 2 can be rotated at two fixed angles.

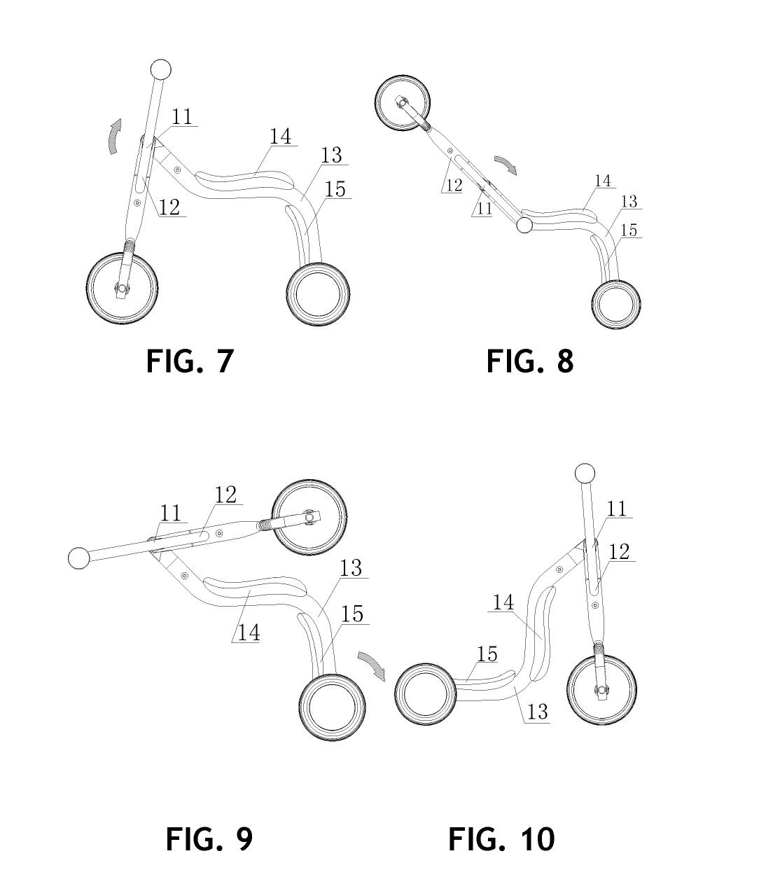

Referring to FIG. 5 to FIG. 6, the positioning device can achieve the rotation of the front fork component 12 and frame component 13. Referring to FIG. 7 to FIG. 10, the rotation of the front fork component 12 and the frame component 13 can achieve the relative conversion between the baby walking frame and scooter, thus through the simple operation to achieve the purpose of combination of the baby walking frame and scooter.

What is claimed is:

1. A positioning device for a joint of a three-wheel stroller comprising:
a decorative and protective cover;
a front fork joint further comprising a limit groove on each side of the front fork joint;
a main pipe joint comprising a long groove located at middle of the main pipe joint;
a compression spring sheathed in the main pipe joint; and
a folder adapter, the folder adapter on the outer side of the compression spring comprising folder adapter holes on both sides of the folder adapter;
wherein the front fork joint is connected to the main pipe joint through a screw shaft , wherein the front fork joint is connected with the folder adapter through a linkage, and wherein the decorative and protective cover is on the outer side of the front fork joint and the folder adapter.

2. The positioning device as described in claim 1, wherein the linkage between the front fork joint and the folder adapter is a rod which can be unloaded quickly.

3. The positioning device as described in claim 1, wherein the front fork joint and the holes of the folder adapter are coaxial.
